(19) United States
(12) Patent Application Publication
(10) Pub. No.: US 2014/0021706 A1
(43) Pub. Date: Jan. 23, 2014

(54) VEHICLE SEAT COMPONENT HAVING SIDE AIR BAG ASSEMBLY

(71) Applicant: Lear Corporation, Southfield, MI (US)

(72) Inventor: Peter Festag, Erding (DE)

(21) Appl. No.: 13/942,926

(22) Filed: Jul. 16, 2013

Related U.S. Application Data
(60) Provisional application No. 61/672,852, filed on Jul. 18, 2012.

(30) Foreign Application Priority Data
Jul. 12, 2013 (DE) 10 2013 213 687.0

(51) Int. Cl. B60R 21/231; B60R 21/207

(52) U.S. Cl. CPC B60R 21/23138; B60R 21/207
USPC 280/730.2

(57) ABSTRACT

A vehicle seat component (12 or 14) having a side air bag assembly (17) including a trigger band (44) that is less stretchable than a trim cover (32) and connected to a tear seam (34) of the trim cover to initially open the tear seam so an air bag (40) can project outwardly through the trim cover to provide seat occupant protection.

### CROSS-REFERENCE TO RELATED APPLICATIONS

This application claims the benefit of U.S. provisional Application No. 61/672,852 filed 18 Jul. 2012 and claims priority to DE 10 2013 213 687.0 filed 12 Jul. 2013, the disclosures of which are incorporated in their entirety by reference herein.

### TECHNICAL FIELD

This invention relates to a vehicle seat component having a side air bag assembly including a trigger band for initiating rupture of a tear seam of a trim cover upon air bag deployment.

### BACKGROUND

Vehicle seat components have previously included side air bag assemblies and conventionally include trim covers that have a tear seam, also known as an air bag release seam, that is ruptured upon air bag upon deployment so the air bag can project outwardly from within the seat to provide occupant protection. See, for example, U.S. Pat. No. 5,752,714 Pripps et al.; U.S. Pat. No. 5,810,389 Yamaji et al.; U.S. Pat. No. 5,860,673 Hasegawa et al.; U.S. Pat. No. 5,927,749 Homier et al.; U.S. Pat. No. 5,967,546 Homier et al.; U.S. Pat. No. 5,997,032 Miwa et al.; U.S. Pat. No. 6,045,151 Wu; U.S. Pat. No. 7,134,685 Panagos et al.; U.S. Pat. No. 7,357,412 Tracht et al.; U.S. Pat. No. 7,543,847 Tracht; U.S. Pat. No. 7,594,678 Schedler; U.S. Pat. No. 7,637,529 Tracht; U.S. Pat. No. 7,695,064 Thomas et al.; U.S. Pat. No. 7,841,656 Tracht et al.; and US Published Application 2011/0193327 Tracht et al.

### SUMMARY

An object of the invention is to provide a vehicle seat component having an improved side air bag assembly.

In carrying out the above object, a vehicle seat component having a side air bag assembly constructed according to the invention includes a frame for mounting on an associated vehicle on which the vehicle seat component is to be used. A seat pad of the seat component is mounted by the frame and has a side extremity, and a trim cover of the seat component extends over the seat pad and includes a side cover panel, an inner cover panel, and a tear seam that connects the side and inner cover panels adjacent the side extremity of the seat pad. An elongate trigger band extends alongside one of the cover panels and has an inner end secured to the frame and an outer end secured to the tear seam, and the trigger band is made of a material that is more resistant to stretching than the one cover panel. A side air bag module is mounted on the frame within the trim cover in a spaced relationship from its tear seam, and the air bag module includes an inflator and an air bag that is inflated by the inflator to project toward the tear seam of the trim cover whereupon force applied by the outer end of the trigger band, which is made of the material that is more resistant to stretching than the one cover panel, pulls open the tear seam so the air bag can project outwardly through the trim cover to provide seat occupant protection.

As disclosed, the trigger band extends alongside the side cover panel and between its ends has a cross-sectional width of 5 to 25 mm.

The tear seam disclosed includes stitching that secures the side and inner cover panels to each other and also secures the outer end of the trigger band to the side and inner cover panels, and the stitching includes two to four, preferable three, stitches that secure the outer end of the trigger band to the side and inner cover panels at the tear seam.

The disclosed air bag module has a length between 185 and 390 mm. extending generally along the direction of the tear seam, and the tear seam has a length with a midway location where the outer end of the trigger band is secured to the tear seam.

Also as disclosed, a fixing seam and/or a J clip secures the inner end of the trigger band to the frame.

The vehicle seat component whose trim cover has the tear seam is disclosed as embodied as a seat back that extends vertically.

### BRIEF DESCRIPTION OF THE DRAWINGS

FIG. 1 is a perspective view of a vehicle seat having a seat back component including a side air bag assembly constructed according to the invention.

FIG. 2 is a side elevational view of the vehicle seat back component taken along the direction of line 2-2 in FIG. 1 with a side air bag module of the assembly illustrated by hidden line representation.

FIG. 3 is a partial sectional view taken through the seat back component along the direction of line 3-3 in FIG. 2 to illustrate a trigger band that initiates rupturing of a trim cover tear seam upon air bag deployment.

FIG. 4 is a perspective view of the seat back trim cover before assembly and also illustrates the trigger band.

FIG. 5 is a sectional view taken alone line 5-5 of FIG. 4 through the trim cover tear seam on another end of the trigger band.

### DETAILED DESCRIPTION

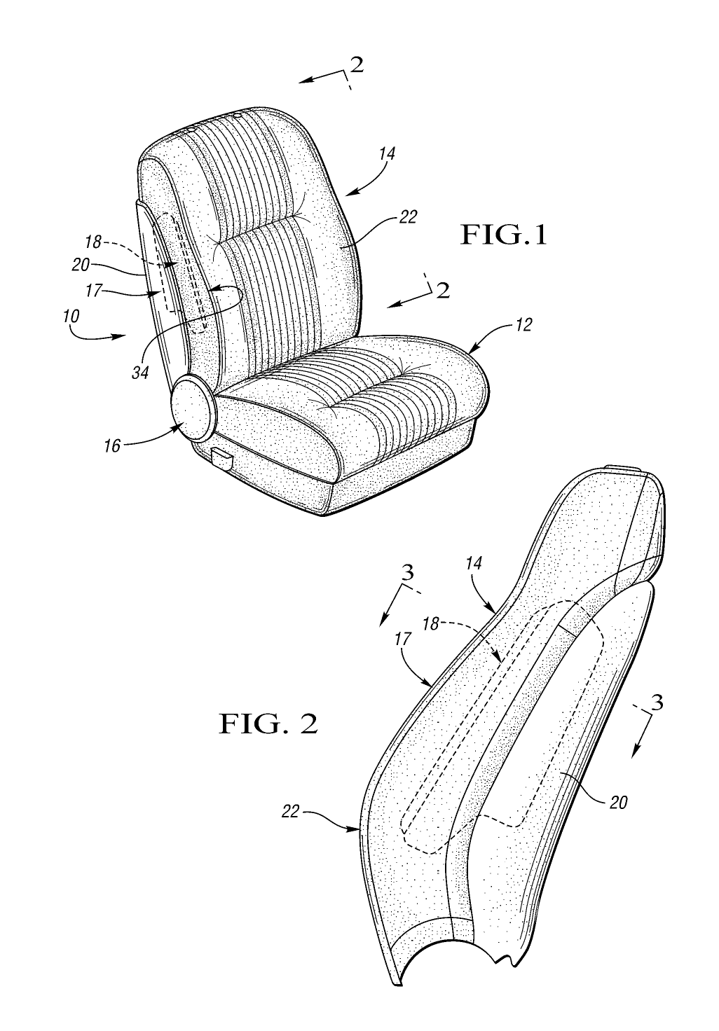

With reference to FIG. 1 of the drawings, a vehicle seat generally indicated by 10 includes a seat bottom 12 for mounting on a vehicle floor and a seat back 14 mounted in a generally upstanding manner on the seat bottom with its angular position controlled in a conventional manner by a recliner generally indicated by 16. The seat back component 14 includes a side air bag assembly 17 that is constructed in accordance with the present invention and includes a side air bag module 18 operable to provide seat occupant protection as is hereinafter more fully described. While the side air bag module 18 is shown on the seat back 14, which is a usage for which it has particular utility, it is also possible for the side air bag module to be utilized with a seat bottom 12 even though the seat back usage is specifically disclosed. Also, as illustrated, the side air bag module 18 is located at a lateral outer side or extremity of the seat to provide protection against adjacent vehicle structure, but it is also possible to have the side air bag module located at the lateral inner side to provide protection against an adjacent vehicle occupant, and it is also possible to have side air bag modules at both outer and inner side locations for protection in both lateral directions. As shown in FIG. 2, the seat back 14 includes a back panel 20 that is conventionally molded from plastic and also includes a front cushion 22 against which the seat occupant leans to provide back support and in which the side air bag module 18 is located.

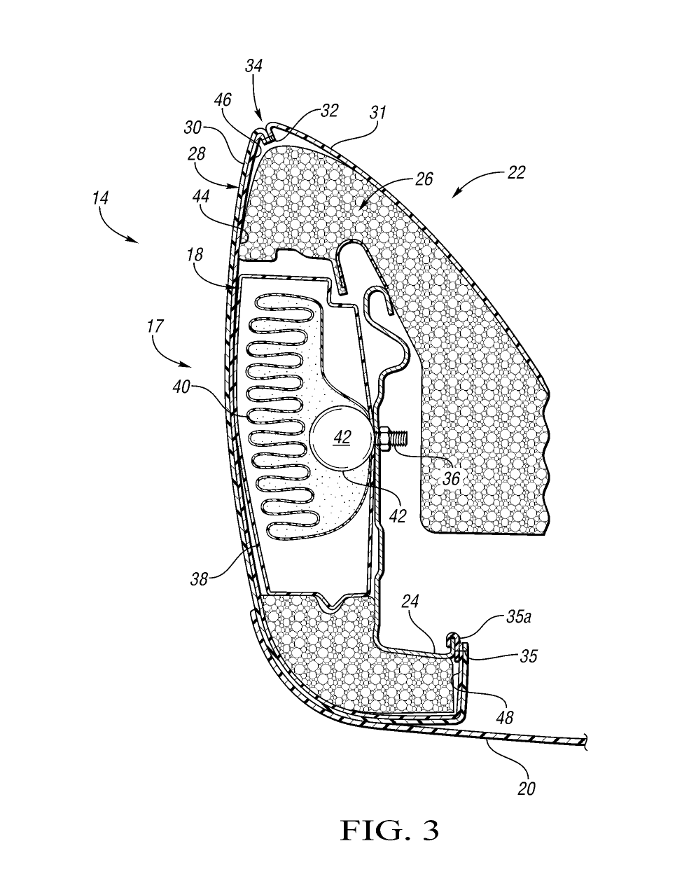

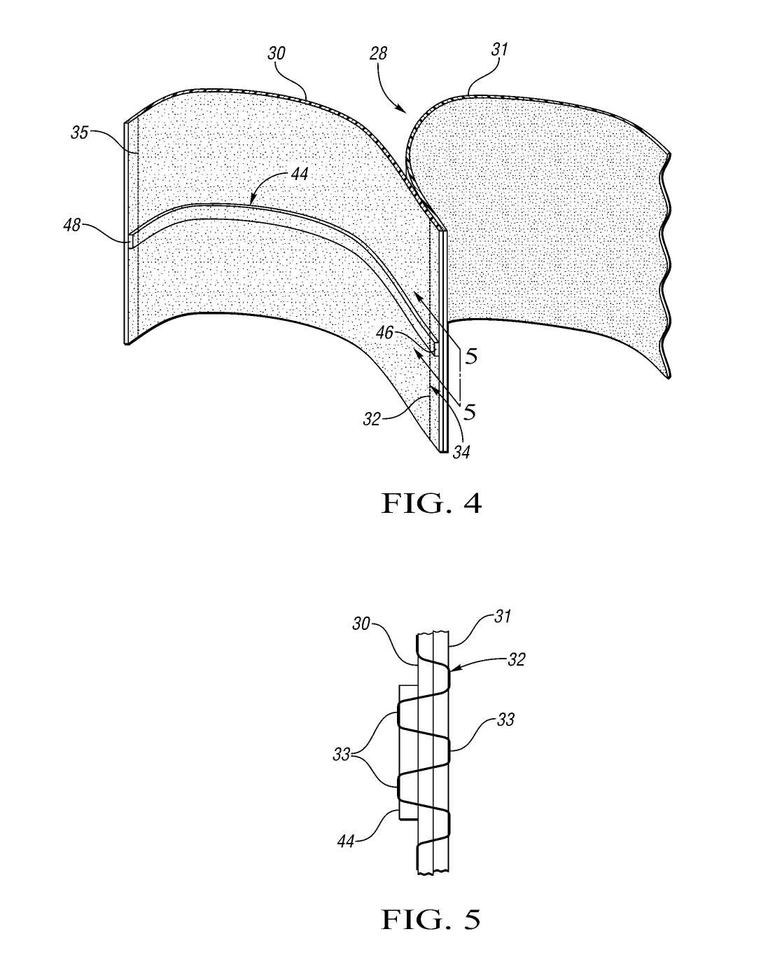

As illustrated in FIG. 3, the seat back component 14 includes a frame 24 and a foam seat pad 26 mounted on the frame in any conventional manner. Both the frame 24 and foam seat pad 26 have opposite side extremities spaced laterally from each other at the opposite lateral sides of the seat. A trim cover made of cloth, vinyl or leather, etc. is generally indicated by 28 and extends over the seat pad 26. The trim cover 28 includes a side cover panel 30 and an inner cover panel 31 connected by stitching 32 to provide a tear seam 34. The side cover panel 30 is secured to the frame 24 in any suitable manner such as by a fixing seam 35 shown in FIGS. 3 and 4 with or without J clips 35a as shown in FIG. 3.

The side air bag module 18 is located within the trim cover 32 mounted on the frame 24, specifically by a threaded or other type of connection 36, and is spaced inwardly from the trim cover tear seam 34. The air bag module 18 includes a housing 38, that may be made of plastic, in which the schematically illustrated air bag 40 is received as is an inflator 42 that inflates the air bag upon deployment.

As shown in FIGS. 3 and 4, the side cover panel 30 of the trim cover 28 includes an elongate trigger band 44 extending from the tear seam 34 to the fixing seam 35 and has outer and inner ends 46 and 48 secured to this panel respectively by the tear seam and the fixing seam. The trigger band 44 between its ends has a cross-sectional width less than the length of the tear seam 34 and is made of a material that is less stretchable than the cover panels 30 and 31 of the trim cover 28. More specifically, in order to be less stretchable than the trim cover 28 and to function, the trigger band is made of a material that has a greater modulus of elasticity in tension and/or a lower tensile elongation than the trim cover material as well as having sufficient ductility and a sufficient tensile strength so as not to fracture upon being subjected to the inflating force of the air bag during its deployment. It should be appreciated that it is also possible for the trigger band 44 to extend alongside the inner cover panel 31 between the frame 24 and the tear seam 34 although the construction shown has particular utility.

The trigger band 44 may be made of the same type of material used to fabricate the air bag 40 (e.g., nylon), for example, and has a width that is less than the length of the tear seam 34. This trigger band 44, due to its characteristic of being less stretchable than the trim cover, upon deployment of the air bag as it is inflated pulls on the tear seam 34 to initiate its rupturing and consequent opening so the air bag can project outwardly from within the seat to provide occupant protection. The stitching 32 of the trigger band at its outer end 46 by the tear seam is provided by two to four stitches 33 with three stitches as shown in FIG. 5 believed to be the best in providing the rupturing to initiate the tear seam opening, and such stitching will normally be provided with the trigger band having a width along its length of 5 to 25 mm.

As illustrated in FIG. 4, the trigger band 44 has its outer end 46 located approximately midway along the length of the tear seam 34, within about 10% of its length from its center location along the length of the tear seam, although it is also possible for the trigger band to be located toward one or the other of the ends of the tear seam depending upon where initial rupturing will provide the best results in air bag deployment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle seat component having a side air bag assembly comprising:
a frame for mounting on an associated vehicle on which the vehicle seat component is to be used;
a seat pad mounted by the frame and having a side extremity;
a trim cover extending over the seat pad and including a side cover panel, an inner cover panel, and a tear seam that connects the side and inner cover panels adjacent the side extremity of the seat pad;
an elongate trigger band extending alongside one of the cover panels and having an inner end secured to the frame and an outer end secured to the tear seam, and the trigger band being made of a material that is more resistant to stretching than the one cover panel; and
a side air bag module mounted on the frame within the trim cover in a spaced relationship from its tear seam, and the air bag module including an inflator and an air bag that is inflated by the inflator to project toward the tear seam of the trim cover whereupon force applied by the outer end of the trigger band, which is made of the material that is more resistant to stretching than the one cover panel, pulls open the tear seam so the air bag can project outwardly through the trim cover to provide seat occupant protection.

2. A vehicle seat component as in claim 1 wherein the trigger band extends alongside the side cover panel between the frame and the tear seam.

3. A vehicle seat component as in claim 1 wherein the trigger band between its ends has a cross-sectional width of between 5 to 25 mm.

4. A vehicle seat component as in claim 2 wherein the tear seam includes stitching that secures the side and inner cover panels to each other and also secures the outer end of the trigger band to the side and inner cover panels.

5. A vehicle seat component as in claim 2 wherein the stitching includes two to four stitches that secure the outer end of the trigger band to the side and inner cover panels at the tear seam.

6. A vehicle seat component as in claim 5 wherein the stitching includes three stitches that secure the outer end of the trigger band to the side and inner cover panels at the tear seam.

7. A vehicle seat component as in claim 1 wherein the air bag module has a length between 185 and 390 mm. extending generally along the direction of the tear seam.

8. A vehicle seat component as in claim 7 wherein the tear seam has a length with a midway location where the outer end of the trigger band is secured to the tear seam.

9. A vehicle seat component as in claim 1 further including a fixing seam and/or a J clip that secures the inner end of the trigger band to the frame.

10. A vehicle seat component as in claim 1 which is embodied as a seat back that extends vertically.

11. A vehicle seat component having a side air bag assembly comprising:
a frame for mounting on an associated vehicle on which the vehicle seat component is to be used;
a seat pad mounted by the frame and having a side extremity;
a trim cover extending over the seat pad and including a side cover panel, an inner cover panel, and a tear seam including stitching that connects the side and inner cover panels adjacent the side extremity of the seat pad;
the side cover panel including an elongate trigger band extending alongside the side cover panel and having an inner end secured to the frame and an outer end secured to the tear seam by the stitching, the trigger band being made of a material that is more resistant to stretching than the side cover panel and having a cross-sectional width of 5 to 25 mm between its ends, and the stitching including two to four stitches; and
a side air bag module mounted on the frame within the trim cover in a spaced relationship from its tear seam, and the air bag module including an inflator and an air bag that is inflated by the inflator to project toward the tear seam of the trim cover whereupon force applied by the outer end of the trigger band, which is made of the material that is more resistant to stretching than the side cover panel, pulls open the tear seam so the air bag can project outwardly through the trim cover to provide seat occupant protection.

12. A vehicle seat back component that extends vertically and has a side air bag assembly comprising:
a frame for mounting on an associated vehicle on which the vehicle seat component is to be used;
a seat pad mounted by the frame and having a side extremity;
a trim cover extending over the seat pad and including a side cover panel, an inner cover panel, and a tear seam including stitching that connects the side and inner cover panels adjacent the side extremity of the seat pad;
the side cover panel including an elongate trigger band extending alongside the side cover panel and having an inner end secured to the frame and an outer end secured to the tear seam by the stitching, the trigger band being made of a material that is more resistant to stretching than the side cover panel and having a cross-sectional width of 5 to 25 mm between its ends, and the stitching including two to four stitches; and
a side air bag module mounted on the frame within the trim cover in a spaced relationship from its tear seam, and the air bag module including an inflator and an air bag that is inflated by the inflator to project toward the tear seam of the trim cover whereupon force applied by the outer end of the trigger band, which is made of the material that is more resistant to stretching than the side cover panel, pulls open the tear seam so the air bag can project outwardly through the trim cover to provide seat occupant protection.
